(19) United States
(12) Patent Application Publication
(10) Pub. No.: US 2025/0187349 A1
(43) Pub. Date: Jun. 12, 2025

(54) CUSTOM PRINTED VINYL RECORDS

(71) Applicants: David Wendell Freel, Gladstone, OR (US); Jennifer Margaret Dawson, Portland, OR (US)

(72) Inventors: David Wendell Freel, Gladstone, OR (US); Jennifer Margaret Dawson, Portland, OR (US)

(21) Appl. No.: 18/760,371

(22) Filed: Jul. 1, 2024

Related U.S. Application Data
(60) Provisional application No. 63/607,650, filed on Dec. 8, 2023.

(51) Int. Cl. B41J 3/407; B41J 11/00

(52) U.S. Cl. CPC B41J 3/4071; B41J 11/00214

(57) ABSTRACT

A process for printing an image onto a custom vinyl record. Ultraviolet (UV) curable ink is printed directly onto a clear blank vinyl record and is then irradiated with a UV light. Sound recording is then added to the resulting vinyl record using a record cutter or lathe. The vinyl record may be printed on a single side or on both sides. The process may comprise the steps of rendering an image file onto a computer prior to transferring to printer software. The image file may be created by a human administrator or an artificial intelligence program. The image may be a single solid color, multiple solid colors, and/or a graphical figure, such as, e.g., a musician.

### CLAIMS OF PRIORITY

This patent application claims priority from:
(1) U.S. provisional patent application No. 63/607,650, entitled ‘Custom printed vinyl records’ filed on Dec. 8, 2023.

The application is incorporated by reference herein in its entirety.

### FIELD OF TECHNOLOGY

This disclosure relates generally to a system and a method for printing an image onto a vinyl record using UV-curable ink.

### BACKGROUND

Adding a custom image to vinyl records involves a process called “vinyl record printing” or “picture disc production,” Picture discs are vinyl records with a printed image on one or both sides, making them a unique collectors item. A general overview of the process includes an initial image selection of the image or artwork to be added to a vinyl record. This can be an artwork, a photograph, a logo, a solid color, or any other graphic. The chosen image is then converted into a suitable format, Digital images are usually used, and they may need to be adjusted for size and color, if necessary. Currently, there are various methods for printing images onto vinyl records. Common methods include adhesive label printing, screen printing and thermal transfer printing. The selected method will determine the type of printing equipment and technology used. Adhesive label printing involves the process of printing onto an adhesive label prior to applying it onto a vinyl record surface. Screen printing uses a stencil (screen) for each color and then pressing ink through the screens onto the vinyl surface. Thermal transfer printing is a digital printing method where the image is printed onto a transfer film and then transferred onto the vinyl using heat and pressure.

### BRIEF DESCRIPTION OF THE DRAWINGS

Figures are illustrated by way of example and are not limited to the accompanying drawings, in which, like references indicate similar elements.

FIGS. 1A-B are flowcharts of a process for printing an image onto a custom double-sided vinyl record.

FIGS. 2A-B are flowcharts of a process for printing an image onto a custom double-sided vinyl record that comprises protective coverings.

FIG. 3 is a flowchart of a process for printing an image onto a custom single-sided vinyl record.

FIGS. 4A-B are flowcharts of a process for printing an image onto a custom single-sided vinyl record that comprises protective coverings.

FIG. 5 shows layers of a custom printed double-sided vinyl record.

FIG. 6 shows layers of a custom printed single-sided vinyl record.

FIGS. 7A-B are a schematic diagrams of a UV ink jet printer.

FIG. 8 is a schematic diagram of a lamination machine.

FIGS. 9A-B are schematic diagrams of a vinyl record cutter.

FIG. 10 illustrates an example computing system for retrieving or creating an image that is to be printed onto a custom blank vinyl record.

### SUMMARY

A process for printing an image onto a custom vinyl record. Ultraviolet (UV) curable ink is printed directly onto a clear blank vinyl record and is then irradiated with a UV light. Sound recording is then added to the resulting vinyl record using a record cutter or lathe. The vinyl record may be printed on a single side or on both sides.

The process may comprise the steps of rendering an image file onto a computer prior to transferring to printer software. The image file may be created by a human administrator or an artificial intelligence program. The image may be a single solid color, multiple solid colors, and/or a graphical figure, such as, e.g., a musician.

### DETAILED DESCRIPTION

Although the present has been described with reference to specific examples, it will be evident that various modifications and changes may be made without departing from their spirit and scope. The modifications and variations include any relevant combination of the disclosed features. Equivalent elements, materials, processes or steps may be substituted for those representatively illustrated and described herein. Certain structures and features may be utilized independently of the use of other structures and features. In addition, the components shown in the figures, their connections, couplings, relationships, and their functions, are meant to be exemplary only, and are not meant to limit the examples described herein.

A process for printing an image onto a custom vinyl record. Ultraviolet (UV) curable ink is printed directly onto a clear blank vinyl record and is then irradiated with a UV light. Sound recording is then added to the resulting vinyl record using a record cutter or lathe.

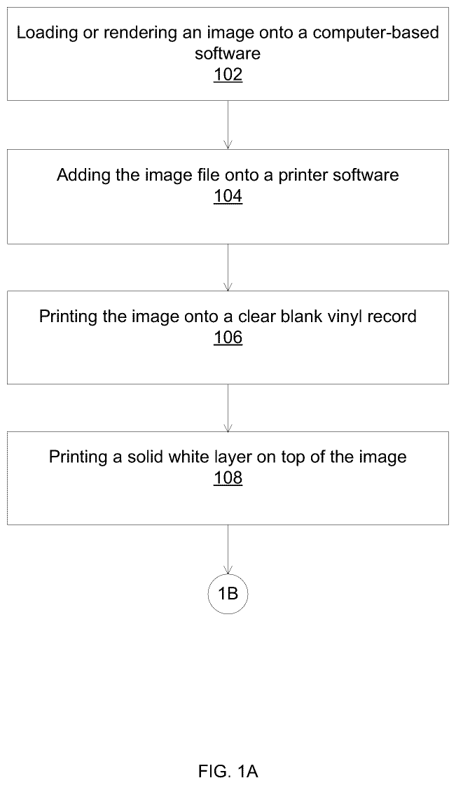

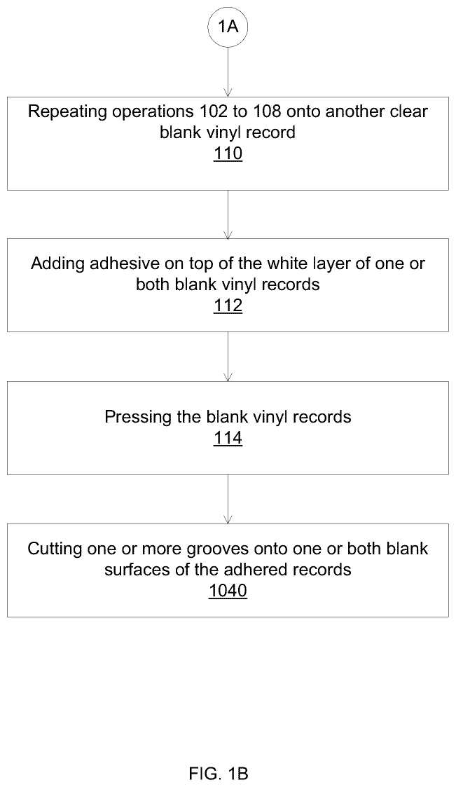

FIGS. 1A-B are flowcharts of a process for printing an image onto a custom double-sided vinyl record. Operation 102 loads or renders an image onto a computer-based software file. For example, the image may be pre-created by an external source, such as, e.g., a third-party provider, and downloaded onto the computer by an administrator. Alternatively, the administrator may create the image using an image editing software. The image may be a single solid color, multiple solid colors, a graphic comprising a figure, such as, e.g., a musical artist, or any combination thereof. In some cases, the image may be rendered by artificial intelligence software. Operation 104 adds the image file onto printer software, such as, e.g., by transferring or downloading the file. The printer software may be configured to interface with a UV inkjet printer. Operation 106 prints the image onto a clear blank vinyl record. The record may be pre-cut, and may comprise any diameter, such as, e.g., 12 inches, 10 inches, or 7 inches. Operation 108 prints a solid white layer directly on top of the image. The white layer may decrease the translucency of the image in addition to decrease an adhesive visually that is later applied. For example, without printing of the white layer, the image may show bubbles formed by the adhesive. Operation 110 repeats operations 102 to 108 onto another clear blank vinyl record. The second image on the second clear blank vinyl record may be the same image or a different image. Operation 112 adds adhesive on top of the white layer of one or both blank vinyl records. Any suitable adhesive may be used, for example, a spray comprising a mixture of solvents, resins, and propellants, such as, e.g., acetone, propane, cyclohexane, petroleum distillates, and hexane. Solvents may help dissolve the adhesive and keep it in a liquid form, while resins may provide the adhesive properties and bonding strength. Propellants may be responsible for dispersing the adhesive in a fine mist when sprayed. Operation 114 presses the blank vinyl records together to facilitate adhesion of the records together. For example, this may be performed with a lamination machine wherein the blanks are pressed together between sets of rollers. Any other method of applying pressure may be used. Operation 116 cuts one or more grooves onto one or both blank surfaces of the adhered records. The blank surfaces may be opposite of the printed surfaces of each individual vinyl record.

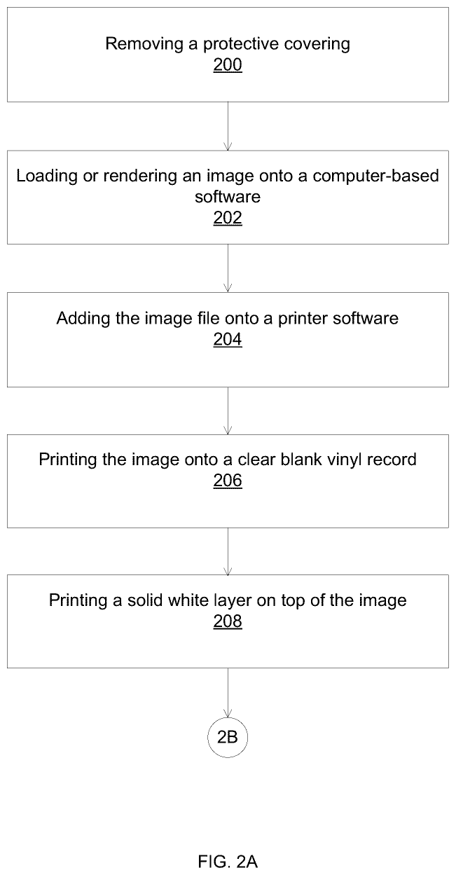

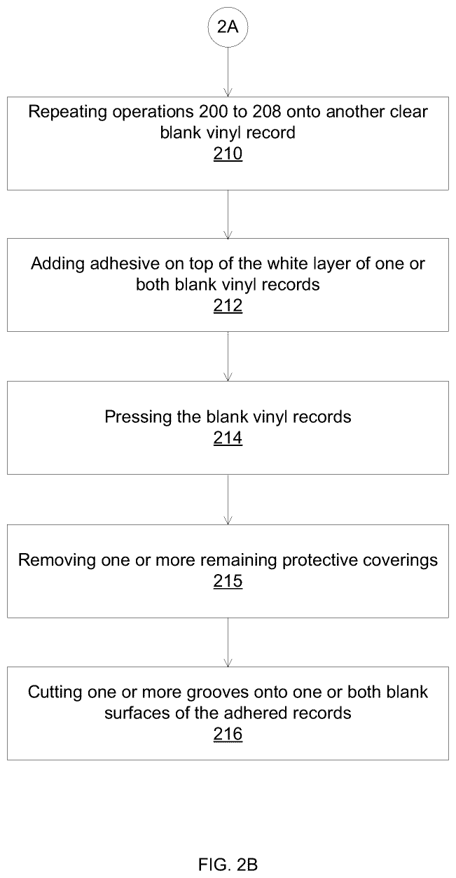

FIGS. 2A-B are flowcharts of a process for printing an image onto a custom double-sided vinyl record that comprises protective coverings. Operation 200 removes a protective covering on a surface of a clear blank vinyl record. The protective covering may be, for example, a layer that is adhered to the surface of the clear blank vinyl record. Operation 202 loads or renders an image onto a computer-based software file. For example, the image may be pre-created by an external source, such as, e.g., a third-party provider, and downloaded onto the computer by an administrator. Alternatively, the administrator may create the image using an image editing software. The image may be a single solid color, multiple solid colors, a graphic comprising a figure, such as, e.g., a musical artist, or any combination thereof. In some cases, the image may be rendered by artificial intelligence software. Operation 204 adds the image file onto printer software, such as, e.g., by transferring or downloading the file. The printer software may be configured to interface with a UV inkjet printer. Operation 206 prints the flipped image onto a clear blank vinyl record on the surface that had its protective covering removed from operation 200. The record may be pre-cut, and may comprise any diameter, such as, e.g., 12 inches, 10 inches, or 7 inches. Operation 208 prints a solid white layer directly on top of the image. The white layer may decrease the translucency of the image in addition to decrease an adhesive visually that is later applied. For example, without printing of the white layer, the image may show bubbles formed by the adhesive. Operation 210 repeats operations 200 to 208 onto another clear blank vinyl record. The second image on the second clear blank vinyl record may be the same image or a different image. Operation 212 adds adhesive on top of the white layer of one or both blank vinyl records. Any suitable adhesive may be used, for example, a spray comprising a mixture of solvents, resins, and propellants, such as, e.g., acetone, propane, cyclohexane, petroleum distillates, and hexane. Solvents may help dissolve the adhesive and keep it in a liquid form, while resins may provide the adhesive properties and bonding strength. Propellants may be responsible for dispersing the adhesive in a fine mist when sprayed. Operation 214 presses the blank vinyl records together to facilitate adhesion of the records together. For example, this may be performed with a lamination machine wherein the blanks are pressed together between sets of rollers. Any other method of applying pressure may be used. Operation 215 removes one or both remaining protective coverings of the adhered blank vinyl records. Operation 216 cuts one or more grooves onto one or both blank surfaces of the adhered records. The blank surfaces may be opposite of the printed surfaces of each individual vinyl record.

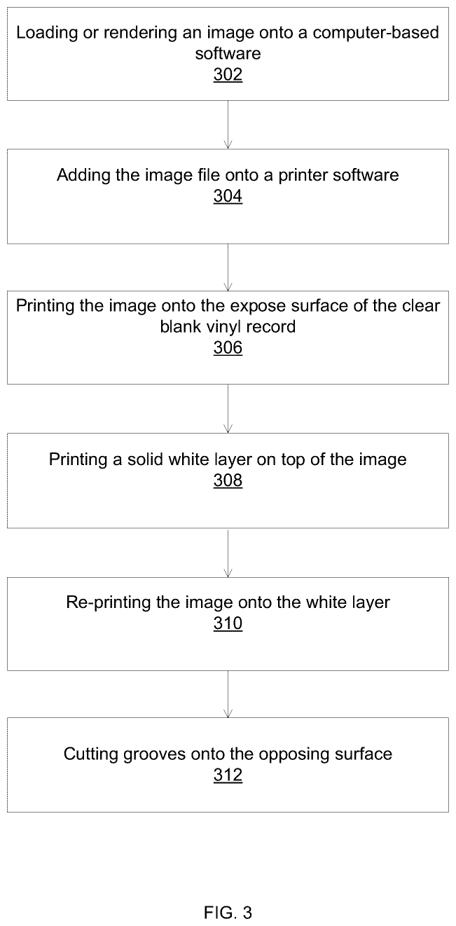

FIG. 3 is a flowchart of a process for printing an image onto a custom single-sided vinyl record. Operation 302 loads or renders an image onto a computer-based software file. For example, the image may be pre-created by an external source, such as, e.g., a third-party provider, and downloaded onto the computer by an administrator. Alternatively, the administrator may create the image using an image editing software. The image may be a single solid color, multiple solid colors, a graphic comprising a figure, such as, e.g., a musical artist, or any combination thereof. In some cases, the image may be rendered by artificial intelligence software. Operation 304 adds the image file onto printer software, such as, e.g., by transferring or downloading the file. The image may be reversed or mirrored, for example, such that the final printed image is displayed correctly, e.g., inversely, if the image is not re-printed in operation 310. The printer software may be configured to interface with a UV inkjet printer. Operation 306 prints the image onto a clear blank vinyl record. The record may be pre-cut, and may comprise any diameter, such as, e.g., 12 inches, 10 inches, or 7 inches. Operation 308 prints a solid white layer directly on top of the image. The white layer may decrease the translucency of the image in addition to decrease an adhesive visually that is later applied. For example, without printing of the white layer, the image may show bubbles formed by the adhesive. Operation 310 re-prints the image from operation 306 directly on top of the white layer. Operation 312 cuts one or more grooves onto the blank surface of the vinyl record. The blank surface may be opposite of the printed surface of the vinyl record.

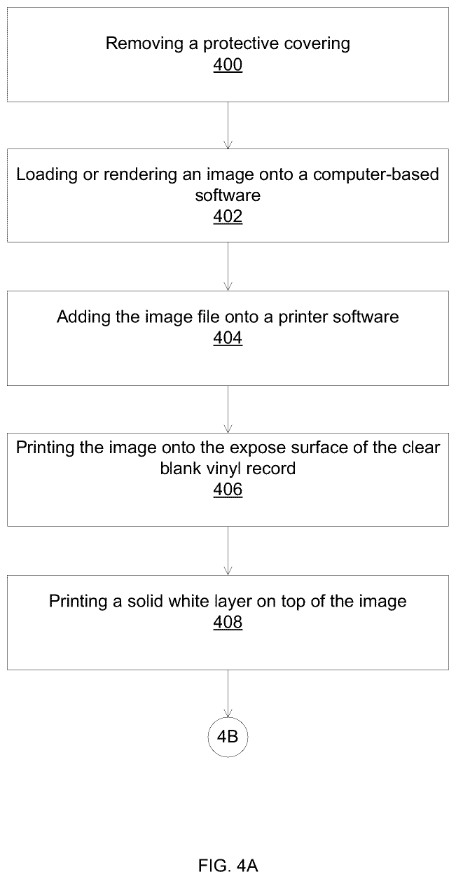

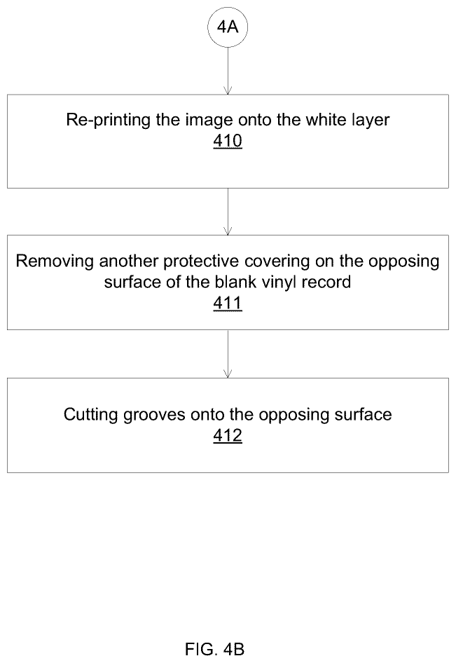

FIGS. 4A-B are flowcharts of a process for printing an image onto a custom single-sided vinyl record that comprises protective coverings. Operation 400 removes a protective covering on a surface of a clear blank vinyl record. The protective covering may be, for example, a layer that is adhered to the surface of the clear blank vinyl record. Operation 402 loads or renders an image onto a computer-based software file. For example, the image may be pre-created by an external source, such as, e.g., a third-party provider, and downloaded onto the computer by an administrator. Alternatively, the administrator may create the image using an image editing software. In some cases, the image may be rendered by artificial intelligence software. The image may be a single solid color, multiple solid colors, a graphic comprising a figure, such as, e.g., a musical artist, or any combination thereof. Operation 404 adds the image file onto printer software, such as, e.g., by transferring or downloading the file. The image may be reversed or mirrored, for example, such that the final printed image is displayed correctly, e.g., inversely, if the image is not re-printed in operation 410. The printer software may be configured to interface with a UV inkjet printer. Operation 406 prints the image onto a clear blank vinyl record on the surface that had its protective covering removed from operation 400. The record may be pre-cut, and may comprise any diameter, such as, e.g., 12 inches, 10 inches, or 7 inches. Operation 408 prints a solid white layer directly on top of the image. The white layer may decrease the translucency of the image in addition to decrease an adhesive visually that is later applied. For example, without printing of the white layer, the image may show bubbles formed by the adhesive. Operation 410 re-prints the image from operation 406 directly on top of the white layer. Operation 411 removes another protective covering on the opposing surface of the blank vinyl record. Operation 412 cuts one or more grooves onto the blank surface of the vinyl record. The blank surface may be opposite of the printed surface of the vinyl record.

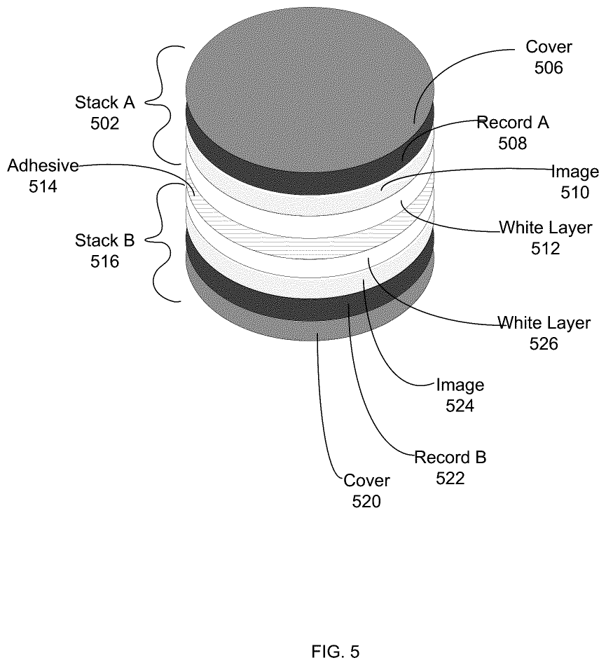

FIG. 5 shows layers of a custom printed double-sided vinyl record. A first vinyl record stack A 502 may comprise protective cover 506. The protective covering may be, for example, a layer that is adhered to a surface of a clear blank vinyl record A 508 configured to shield the surface from physical damage, such as, e.g., scratches. Protective cover 506 may be removed prior to cutting grooves onto the surface of vinyl record A 508. Vinyl record A 508 may comprise another protective cover on the opposing surface that was removed prior to printing of an image 510 onto vinyl record A 508. Printed image 510 may be added to the underside, or lower surface of record A 508, by a printer, such as, e.g., a UV printer. The UV printer may, for example, eject UV-curable ink onto the lower surface of record A 508 prior to irradiation of the ink. The image may be pre-created by an external source, such as, e.g., a third-party provider, and downloaded onto the computer by an administrator. Alternatively, the administrator may create the image using an image editing software. The image may be a single solid color, multiple solid colors, a graphic comprising a figure, such as, e.g., a musical artist, or any combination thereof. The printed image 510 may be flipped horizontally and/or vertically, for example, such that the final printed image is displayed correctly, e.g., inversely. For example, the image may be inverted or displayed as a mirror image. A solid white layer 512 may be printed, such as, e.g., by the UV printer, directly onto the image 510. The white layer 512 may be configured to decrease the translucency of the image 510 in addition to decrease an adhesive 514 visually. For example, without printing of white layer 512, image 510 may show bubbles formed by adhesive 514.

Record stack B 516 may comprise the same pattern of layers as record A 502; however, the layers in record B 516 may be inversed, or positioned upside down, when compared to record A 502. Specifically, second vinyl record stack B 516 may protective cover 520. The protective covering may be, for example, a layer that is adhered to a surface of a clear blank vinyl record B 522 configured to shield the surface from physical damage, such as, e.g., scratches. Protective cover 520 may be removed prior to cutting grooves onto the surface of vinyl record B 522. Vinyl record B 522 may comprise another protective cover on the opposing surface that was removed prior to printing of an image 524 onto vinyl record B 522. Printed image 524 may be added to the upper side, or top surface of record B 522, by a printer, such as, e.g., a UV printer. The UV printer may, for example, eject UV-curable ink onto the top surface of record B 522 prior to irradiation of the ink. The image may be pre-created by an external source, such as, e.g., a third-party provider, and downloaded onto the computer by an administrator. Alternatively, the administrator may create the image using an image editing software. The image may be a single solid color, multiple solid colors, a graphic comprising a figure, such as, e.g., a musical artist, or any combination thereof. The printed image 524 may be flipped horizontally and/or vertically, for example, such that the final printed image is displayed correctly, e.g., inversely. For example, the image may be inverted or displayed as a mirror image. A solid white layer 526 may be printed, such as, e.g., by the UV printer, directly onto the image 524. The white layer 526 may be configured to decrease the translucency of the image 524 in addition to decrease an adhesive 528 visually. For example, without printing of white layer 526, image 524 may show bubbles formed by adhesive 514.

Record stack A 502 and record stack B 516 may be joined together by adhesive 514 between white layer 512 and white layer 526. Laminate 504 and laminate 518 may be configured to hold stack A 502 and stack B 516 together to permit adhesive 514 time to harden.

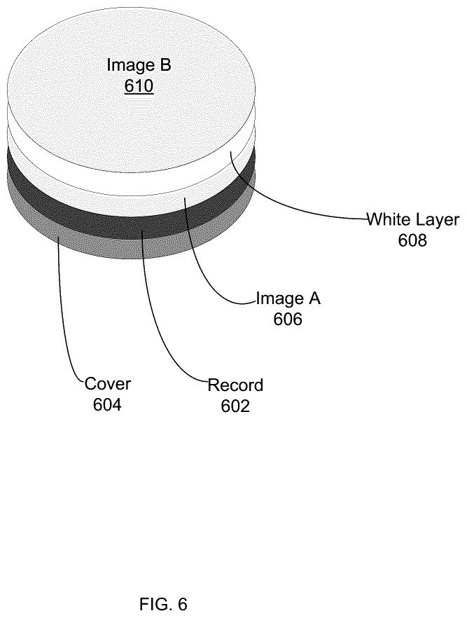

FIG. 6 shows layers of a custom printed single-sided vinyl record. The vinyl record 602 may comprise a bottom protective cover 604. The protective covering may be, for example, a layer that is adhered to a surface of a clear blank vinyl record 602 configured to shield the surface from physical damage, such as, e.g., scratches. Protective cover 604 may be removed prior to cutting grooves onto the surface of vinyl record 602. Vinyl record 602 may comprise another protective cover on the opposing surface that was removed prior to printing of an image A 606 onto vinyl record 602. Printed image A 606 may be added to the upper side, or top surface, of record 602, by a printer, such as, e.g., a UV printer. The UV printer may, for example, eject UV-curable ink onto the top surface of record 602 prior to irradiation of the ink. The image may be pre-created by an external source, such as, e.g., a third-party provider, and downloaded onto the computer by an administrator. Alternatively, the administrator may create the image using an image editing software. The image may be a single solid color, multiple solid colors, a graphic comprising a figure, such as, e.g., a musical artist, or any combination thereof. A solid white layer 608 may be printed, such as, e.g., by the UV printer, directly onto the image A 606. The white layer 608 may be configured to decrease the translucency of the image A 606. Image B 610 may be printed on top of white layer 608, and may be visually identical to image A 606. In some cases, image B 610 is not visually identical to image A 606. Image A 606 may be printed in a mirror image or an inverted configuration if image B 610 is not printed onto white layer 608, since the top layer is what shows to a viewer.

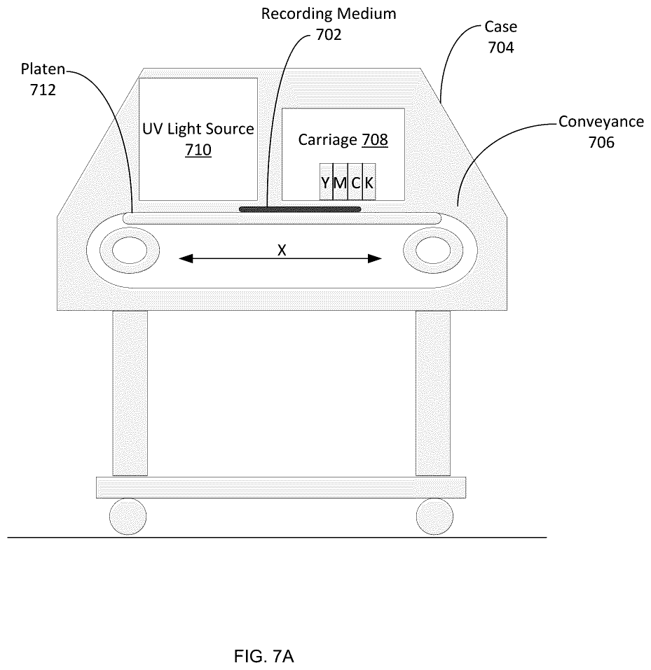

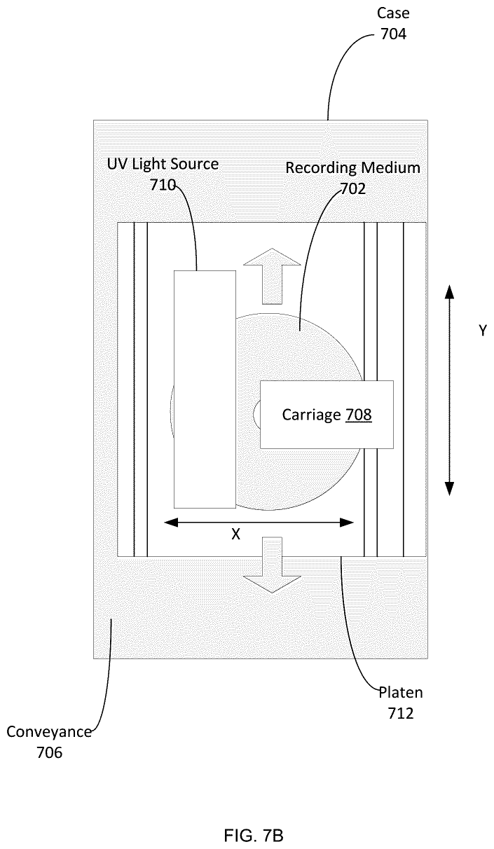

FIGS. 7A-B are a schematic diagrams of a UV ink jet printer. FIG. 7A shows a side view of the printer, while FIG. 7B is a top view of the printer. The printer may be configured to add an image to recording medium 702 by ejecting and depositing UV ink onto recording medium 702, which is then cured by irradiation with ultraviolet (UV) rays. The outer portion of the printer may be covered, for example, by case 704. The printer includes a conveyance 706 for feeding the recording medium 702 during printing, a carriage 708 having recording heads yellow (Y), magenta (M), cyan (C), and black (K) mounted thereon for ejecting and depositing the UV ink on the recording medium 702, and a UV light source 710 for irradiating ultraviolet rays onto the recording medium 702 on which the ink is deposited. The recording medium 702 may, for example, be a vinyl record comprising the diameters of 12 inches, 10 inches, or 7 inches.

The conveyance 706 may be disposed at a lower portion of the case 704, and may be configured to convey the recording medium 702 before image printing. Conveyance 706 comprises, for example, a conveyance motor and a conveyance roller. A platen 712 oriented substantially horizontal below UV light source 710 and carriage 708 may be configured to support the backside surface of the recording medium 702 while exposing its upper surface. The conveyance 706, at the time of printing, moves the recording medium 702 in a direction of arrow X every time the ejection of UV ink is completed for a predetermined area on recording medium 702. Meanwhile, the recording medium 702 is to be printed on the upper surface.

The carriage 708 accommodates a plurality of recording heads corresponding to the number of colors to be used for printing images onto recording medium 702, each head having nozzle orifices (not shown) facing downward. Carriage 708 is reciprocally movable by a moving mechanism (not shown) in a direction of the arrow Y, as shown in FIG. 7B, with respect to the main body of the UV ink jet printer. Repetition of this reciprocal movement constitutes recording head scanning. Each recording head ejects UV ink supplied from an ink tanks (not shown) through a plurality of nozzle orifices toward the recording medium 702 with a plurality of jetting means. The UV ink may comprise, for example, a pigment, a polymerizable compound, and a photo reaction initiator, and has the property of being cured by cross-linking or polymerization with the initiator acting as a catalyst by irradiation of ultraviolet rays.

The recording heads eject and deposit UV ink droplets onto a predetermined area on the recording medium 702 according to image information sent from a control means (not shown) during the scanning phase that the heads move from one end to the other end of the recording medium 702 in the Y direction. After carrying out ejection of UV ink to the predetermined area on the recording medium 702 with proper times of the scanning, the recording medium feeding section 706 advances the recording medium 702 in the X direction. Thereafter, the recording heads scan again and eject UV ink to a next predetermined area adjacent to the former predetermined area in the X direction. Repetition of the operations described above allows forming an image with UV ink droplets aggregated on the recording medium 702.

The UV light source 710 is disposed besides carriage 708, and has one or more lamps, such as, e.g., high-pressure mercury lamp, metal halide lamp, black light, cold cathode lamp, hot-cathode tube, cathode ray tube, light emitting diode (LED), and/or semiconductor laser. Each lamp can emit light with stable irradiation energy, the peak wavelength of which is within a wavelength range of ultraviolet rays that can cure the UV ink. Each lamp is oriented such that the emitting portion faces downward. The wavelength and energy of ultraviolet rays irradiated by the UV light source 710 can be changed, for example, by a control means. The control means includes a central processing unit (CPU), a read only memory (ROM), a random access memory (RAM), and a user interface to control each component of the printer.

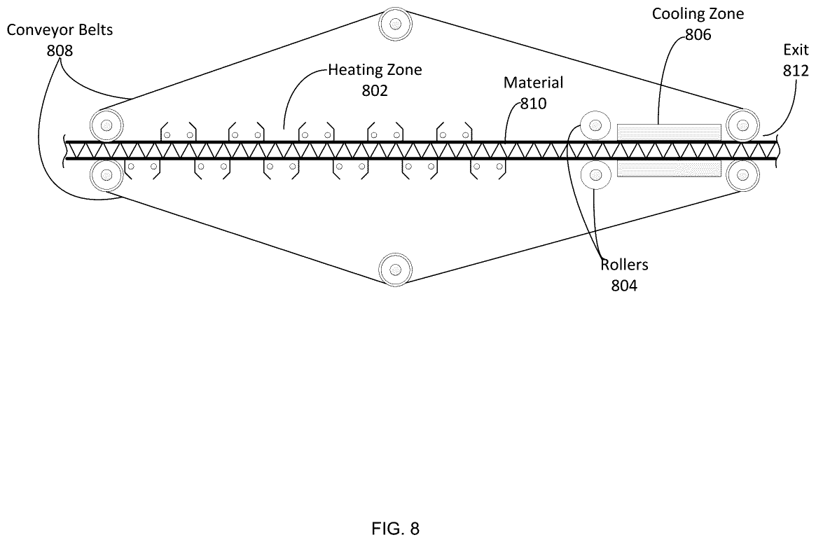

FIG. 8 is a schematic diagram of a lamination machine. Although a thermal laminator is discussed here, any other type of lamination systems may be used, such as, e.g., roll laminators, pouch laminators, cold laminators, and industrial laminators. The lamination machine may comprise a heating zone 802, a pair of opposing lamination rollers 804, and a final product cooling zone 806. A single pair of opposing upper and lower conveyor belts 808 moves material 810, such as, e.g., a vinyl record, through heating zone 802 between lamination rollers 804. Lamination rollers 804 may be configured to apply even pressure to the laminating film and material 810 to ensure proper adhesion and remove any imperfections, and may move in sync when the machine is in operation. Heating zone 802 may include a heat source, such as, e.g., a heating element or plate, configured to generate controlled heat. The temperature of the heat source may be adjusted via a control means (not shown), allowing an administrator to customize the heat level based on the type of material being laminated. The control means may also provide options for adjusting the speed at which the document or material moves through the machine. Material 810 is then conveyed through cooling zone 806 for in preparation for departure from the machine exit 812.

It is the conventional process for making vinyl records to first record an audio performance, such as, e.g., a song or a speech, onto high quality magnetic tape and to use this magnetic tape either with or without alterations to cut a master record disc, such as, e.g., a lacquer disc, with a record cutter or lathe. The master record disc is in turn electroplated with a metal, usually nickel, to create a metal master. This process involves immersing the lacquer in a solution, which deposits a thin metal layer onto the disc. The metal master is used to create stampers, which are negative impressions of the metal master and are used to press the vinyl records. The stampers are mounted on the presses, one for each side of the record. Vinyl pellets are heated and pressed between the stampers. The stampers create the grooves on the vinyl discs, and the excess vinyl is trimmed to create the final shape of the record. Labels are often applied during the pressing process. The pressed records are then cooled and removed from the press.

More recently, advances in vinyl record cutting has simplified the processes significantly. A record cutter or lathe may now be cut a vinyl record directly without the need of creating a master for stamping. In summary, an audio communicatively coupled to a record cutter or lathe, which carves the tracks into a rotating vinyl records. As the tracks are cut, the shavings are sucked away from the record.

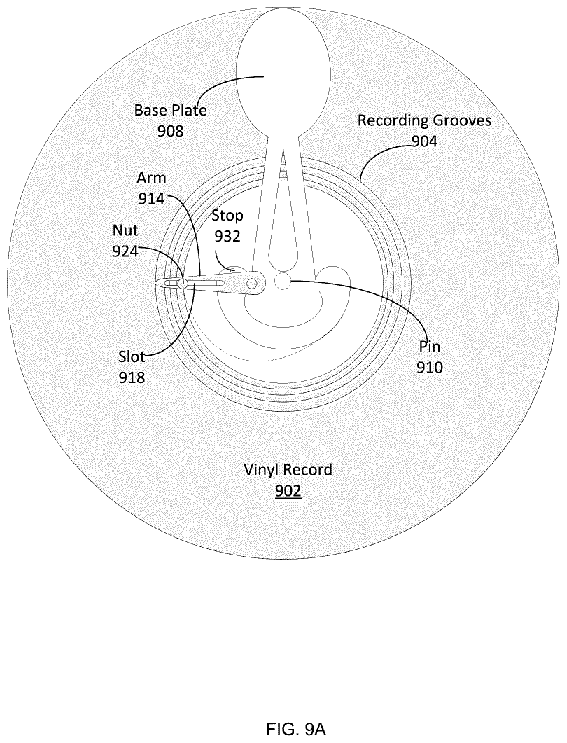

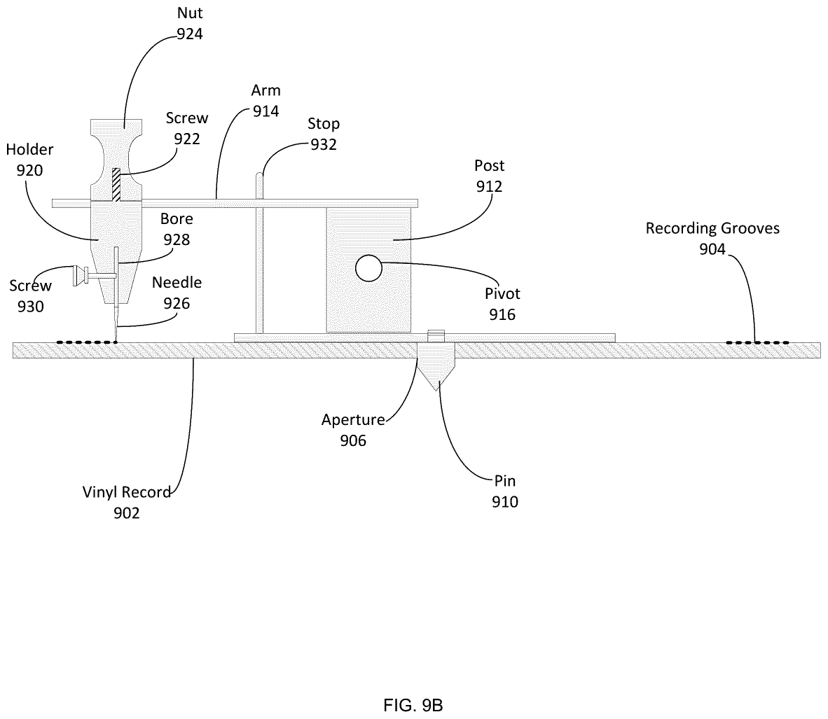

FIGS. 9A-B are schematic diagrams of a vinyl record cutter. FIG. 9A is a top view of the vinyl record cutter, and FIG. 9B shows a sectional view of the vinyl record cutter. The record cutter may comprise a base portion to support vinyl record 902, which includes sound recording grooves 904, either of the hill and dale or lateral wave configurations. Central opening or aperture 906 may be disposed in a middle portion of vinyl record 902 and configured to receive a drive spindle of a motor of the machine to which the vinyl record 902 may be applied. The drive spindle may be responsible for rotating vinyl record 902 at a constant speed.

A base plate 908 having a flat under surface is adapted to lie upon the top surface of vinyl record 902. This base plate 908 preferably comprises rigid pin 910, near one end, of a size suitable to enter the aperture 906 of vinyl record 902 to which the device is applied. The shape of base plate 908 is such as to form a semi-circle about the pin 910. This semi-circular portion may comprise having a radius corresponding to the distance from the central point of the record, which is to be regarded as the innermost limit of the movement of a needle of a tone arm a suitable sound reproducing machine. The remainder of the outline of base plate 908 may comprise a relatively narrow portion extending radially from central pin 910 adapted for convenience in handling of the device, and extended sufficiently to give a broad surface for engagement with vinyl record 902 as to avoid great pressure upon any particular point thereof. Eccentrically of the semi-circular portion of base plate 908 is pivotally mounted an upright post 912, to the top of which is attached a substantially horizontally extending arm 914.

The top of post 912 may be curved in order to permit movement of arm 914 in a vertical plane about pivot 916. The arm 914 is provided with a slot_18, extending in a straight line from the center of pivot 916 of post 912. Within slot 914 is slidably mounted a groove cutting device, which comprises a holder 920 having a tongue or raised portion for preventing rotative movement of the holder 920, and a screw 922 extending upwardly through the slot and upon which is screwed a headed nut 924. It is readily apparent that on unloosening the nut 924, the cutter holder 920 may be readily moved along slot 918 to any desired position and fastened there by screwing down nut 924. The groove cutting device is shown as a needle 926 clamped in a bore 928 formed in the holder 920, by means of set screw 930.

In operation, the base plate 908 is placed upon the vinyl record 902 with pin 910 passing through the central opening or aperture 906 of vinyl record 902. The radial arm 914 is then brought into position against a stop 932, in which position of the cutter holder 920 is slidably moved along slot 918 until the cutter comes into position at the innermost portion of the sound recording grooves on the vinyl record 302. The cutter holder 920 is then fixed in this position on the arm 914, which is moved about its pivot 912 with the cutter holder 920 pressed against the vinyl record 902 so that the needle 926 forms a groove on the surface of vinyl record 902. As arm 914 is pivoted eccentrically at the circular portion of base plate 908, its movement follows a curve which approaches the center of the vinyl record 902, terminating when the needle 926 or the cutter holder 920 comes into contact with the semi-circular edge of base plate portion 908. This semi-circular portion thus determines the radial distance from the center of the vinyl record 902 at which the groove cut terminates.

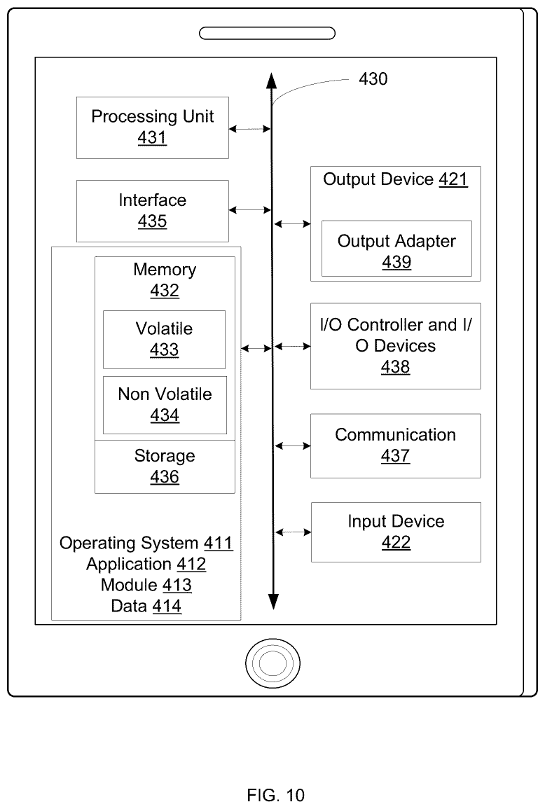

FIG. 10 illustrates an example computing system for retrieving or creating an image that is to be printed onto a custom blank vinyl record. The processing unit 1031 may be any of various available processors, such as single microprocessor, dual microprocessors or other multiprocessor architectures. The system bus 1030 may be any type of bus structures or architectures, such as 12-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), or Small Computer Systems Interface (SCST).

The system memory 1032 may include volatile memory 1033 and nonvolatile memory 1034. Nonvolatile memory 1034 may include read only memory (ROM), programmable ROM (PROM), electrically programmable ROM (EPROM), electrically erasable ROM (EEPROM), or flash memory. Volatile memory 1033, may include random access memory (RAM), synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), or direct Rambus RAM (DRRAM).

The device also includes storage media 1036, such as removable/non-removable, volatile/nonvolatile disk storage, magnetic disk drive, floppy disk drive, tape drive, Jaz drive, Zip drive, LS-100 drive, flash memory card, memory stick, optical disk drive such as a compact disk ROM device (CD-ROM), CD recordable drive (CD-R Drive), CD rewritable drive (CD-RW Drive) or a digital versatile disk ROM drive (DVD-ROM). A removable or non-removable interface 1035 may be used to facilitate connection.

The device may further include software to operate, such as an operating system 1011, system applications 1012, program modules 1013 and program data 1014, which are stored either in system memory 1032 or on disk storage 1036. Various operating systems or combinations of operating systems may be used.

Input device 1022 may be used to enter commands or data, and may include a pointing device such as a mouse, trackball, stylus, touch pad, keyboard, microphone, joystick, game pad, satellite dish, scanner, TV tuner card, sound card, digital camera, digital video camera, web camera, and the like, connected through interface ports 1038. Interface ports 1038 may include a serial port, a parallel port, a game port, a universal serial bus (USB), and a 1394 bus. The interface ports 1038 may also accommodate output devices 1021. For example, a USB port may be used to provide input to the device and to output information from the device to an output device 1021. Output adapter 1039, such as video or sound cards, is provided to connect to some output devices such as monitors, speakers, and printers.

A number of examples have been described. Nevertheless, it will be understood that various modifications may be made without departing from the spirit and scope of the claimed invention. In addition, the logic flows depicted in the figures do not require the particular order shown, or sequential order, to achieve desirable results. Other steps may be provided, or steps may be eliminated, from the described flows, and other components may be added or removed. Accordingly, other examples are within the scope of the following claims.

What is claimed is:

1. A method, comprising:
rendering a first image file onto a computer,
wherein the first image file comprises at least one of a single solid color, multiple solid colors, and a graphical figure;
transferring the first image file onto a printer software;
printing the first flipped image onto a first clear blank vinyl record,
wherein the first clear blank vinyl record is pre-cut and measures 12 inches, 10 inches, or 7 inches in diameter; and
printing a solid white layer directly on top of the first image.

2. The method of claim 1,
wherein the first image is rendered by artificial intelligence software.

3. The method of claim 1,
wherein the first image is rendered by a human administrator.

4. The method of claim 1, further comprising:
rendering a second image file onto a computer;
wherein the second image file comprises at least one of a single solid color, multiple solid colors, and a graphical figure;
transferring the second flipped image file onto a printer software;
printing the second image onto a second clear blank vinyl record, and
wherein the second clear blank vinyl record is pre-cut and measures 12 inches, 10 inches, or 7 inches in diameter.

5. The method of claim 4,
wherein the second image is the same as the first image.

6. The method of claim 4,
wherein the second image is different from the first image.

7. The method of claim 4, further comprising:
printing a solid white layer directly on top of the printed second image.

8. The method of claim 7, further comprising:
applying adhesive on top of the white layer of one or both clear blank vinyl records.

9. The method of claim 8, further comprising:
pressing and adhering the first and the second clear blank vinyl records together.

10. The method of claim 9, further comprising:
wherein pressing of the first and second clear blank vinyl records is performed with a lamination machine.

11. The method of claim 10, further comprising:
cutting one or more grooves onto one or both blank surfaces of the adhered records, and
wherein the one or more blank surfaces may be opposite of the printed surfaces of each individual clear blank vinyl record.

12. A method, comprising:
rendering an image file onto a computer, and
wherein the image file comprises at least one of a single solid color, multiple solid colors, and a graphical figure.

13. The method of claim 12,
wherein the image is rendered by artificial intelligence software.

14. The method of claim 12,
wherein the image is rendered by a human administrator.

15. The method of claim 12, further comprising:
transferring the image file onto a printer software.

16. The method of claim 15, further comprising:
reversing the image.

17. The method of claim 16, further comprising:
printing the flipped image onto a clear blank vinyl record, and
wherein the clear blank vinyl record is pre-cut and measures 12 inches, 10 inches, or 7 inches in diameter.

18. The method of claim 17, further comprising:
printing a solid white layer directly on top of the printed flipped image.

19. The method of claim 18, further comprising:
cutting one or more grooves onto a surface of the clear blank vinyl record.

20. The method of claim 19, further comprising:
wherein the surface may be opposite of the printed surface of the clear blank vinyl record.
